(19) United States
(12) Patent Application Publication
(10) Pub. No.: US 2010/0271345 A1
(43) Pub. Date: Oct. 28, 2010

(54) Electronic White Board Capable of Printing Partial Data Thereon

(75) Inventors: Cheng-Lu Liu, Hsin-Chu (TW); Yun-Hsiang Yeh, Miaoli (TW); Yi-Ting Chen, Hsinchu (TW)

Correspondence Address: SQUIRE, SANDERS & DEMPSEY L.L.P., 275 BATTERY STREET, SUITE 2600, SAN FRANCISCO, CA, 94111-3356, US

(73) Assignee: WALTOP INTERNATIONAL CORPORATION, Hsinchu (TW)

(21) Appl. No.: 12/539,593

(22) Filed: Aug. 11, 2009

(30) Foreign Application Priority Data
Apr. 28, 2009 (CN) 200910137253.2

(51) Int. Cl. G09G 5/00

(52) U.S. Cl. 345/204

(57) ABSTRACT

The present invention relates to an electronic white board capable of printing partial data thereon, and particularly relates to a non-interactive white board capable of printing partial data thereon. The electronic white board comprises a writing area for inputting the data to the electronic white board by writing, a selecting device for selecting the part of the data on the writing area to be printed, and a defining device for defining which part on the writing area is selected by the selecting device. In the present invention, the defining device defines a rectangle zone, a circle zone, an elliptical zone or a polygonal zone on the writing area for printing by inputting one or more points or lines with the selecting device.

### FIELD OF THE INVENTION

The present invention relates to an electronic white board capable of printing partial data thereon, and particularly, relates to a non-interactive white board capable of printing partial data thereon.

### BACKGROUND OF THE INVENTION

In recent years, with the tend that more digital technology is applied in life and work and the electronic technology is developed, more and more electronic white boards are used in meetings and schools, especially non-interactive electronic white boards. In meetings or schools, symbols, words and drawings written on a non-interactive electronic white board can be printing on paper to be a record of the meeting or a teaching handout by the non-interactive electronic white board.

Referring to FIG. 1, it is a three-dimensional diagram illustrating a conventional non-interactive electronic white board 1. The conventional non-interactive electronic white board 1 comprises a writing area 2. Referring to FIG. 1B, data of symbols, words, or drawings are inputted on writing area 2 by a pen. Although data on writing area 2 can be printed by the conventional non-interactive electronic white board 1, but the conventional non-interactive electronic white board 1 can not select which part of data 4 of symbols, words, and drawings on writing area 2 to be printed. All data on the writing area 2 will be printed on a paper 3 when data printing is performed by the conventional non-interactive electronic white board 1, as FIG. 1C shows. After printing, no matter which part of the data on writing area 2 are desired to be printed, all data on writing area 2 will be printed on paper 3. However, in a meeting or a school, part of the data of symbols, words, drawings and etc. are just written for illustration or interpretation without importance. Therefore, it is not necessary to print all data on the paper and only part of data needs to be printed on the pager 3. However, the conventional non-interactive electronic white board 1 is incapable of selecting which part of the data (such as the important items of the data) on the writing area 2 to be printing on the paper 3. Hence, it has a need to provide an electronic white board capable of printing partial data thereon and a method for printing partial data on the electronic white board to a paper. Only the desired part of the data of symbols, words and drawings on writing area of the electronic white board is printed to a paper without any undesired part of the data being printed.

### SUMMARY OF THE INVENTION

A feature of this invention is to provide an electronic white board capable of printing partial data thereon for printing the desired or important part of the data thereon to a paper without any desired part of the data.

Another feature of this invention is to provide a method for printing partial data on an electronic white board for selecting the area to be printed and for adjusting the printing size freely.

In one embodiment of the present invention, an electronic white board capable of printing partial data thereon is disclosed. The electronic white board comprises a writing area for inputting data to the electronic white board by writing, a selecting device for selecting an area on the writing area wherein data in the area are selected to be printed, and a defining device for defining a scope of the area. The defining device defines a rectangle zone, a circle zone, an elliptical zone or a polygonal zone on the writing area to be a printing area by inputting one or more points or lines with the selecting device. The data in the printing area can be printed independently without any undesired data on the writing area to be printed.

In one embodiment of the present invention, a method for printing partial data on an electronic white board is disclosed. The disclosed method comprises following steps: first, inputting data of symbols, words, or drawings to the electronic white board by writing; next, selecting an area on the writing area to be printed by inputting one or more points or lines; and then, defining scope of the area for printing with a rectangle zone, a circle zone, an elliptical zone or a polygonal zone; and finally, printing all of the data in the scope of of the area.

Therefore, the effect achieved with the present invention, that is not found in prior art, is to provide an electronic white board capable of printing partial data thereon and a method for printing partial data on an electronic white board. By the electronic white board and the method, only the desired data of symbols, words, or drawings is selected and printed, but not all data on the writing area of the electronic white board is printed. Therefore, the important data on the writing area can be printed independently without undesired data.

### BRIEF DESCRIPTION OF THE DRAWINGS

FIG. 1A is three-dimensional view of a conventional non-interactive electronic white board.

FIG. 1B is in plan form diagram illustrating data on a writing area of conventional non-interactive electronic white board of FIG. 1A.

FIG. 1C is in plan form diagram illustrating the data of FIG. 1B being printed on a page.

FIG. 2A to FIG. 2C are plane-form view of non-interactive electronic white boards with different selecting device in accordance with embodiments of the present invention.

FIG. 3A to FIG. 3B are plane-form view of the writing area of non-interactive electronic white boards with a rectangle zone for defining the area to be printed in accordance with embodiments of the present invention.

FIG. 4A and FIG. 4B are plane-form view of the writing area of non-interactive electronic white boards with a circle zone for defining the area to be printed in accordance with embodiments of the present invention.

FIG. 5A and FIG. 5B are plane-form view of the writing area of non-interactive electronic white boards with an elliptical zone for defining the area to be printed in accordance with embodiments of the present invention.

FIG. 6 is plane-form view of the writing area of the non-interactive electronic white board with a polygonal zone for defining the area to be printed in accordance with one embodiment of the present invention.

FIG. 7A and FIG. 7B are plane-form view of the writing area of non-interactive electronic white boards for adjusting the printing size on a paper in accordance with embodiments of the present invention.

FIG. 8 is a flow chart illustration of a method for printing partial data on an electronic white board in accordance with an embodiment of the present invention.

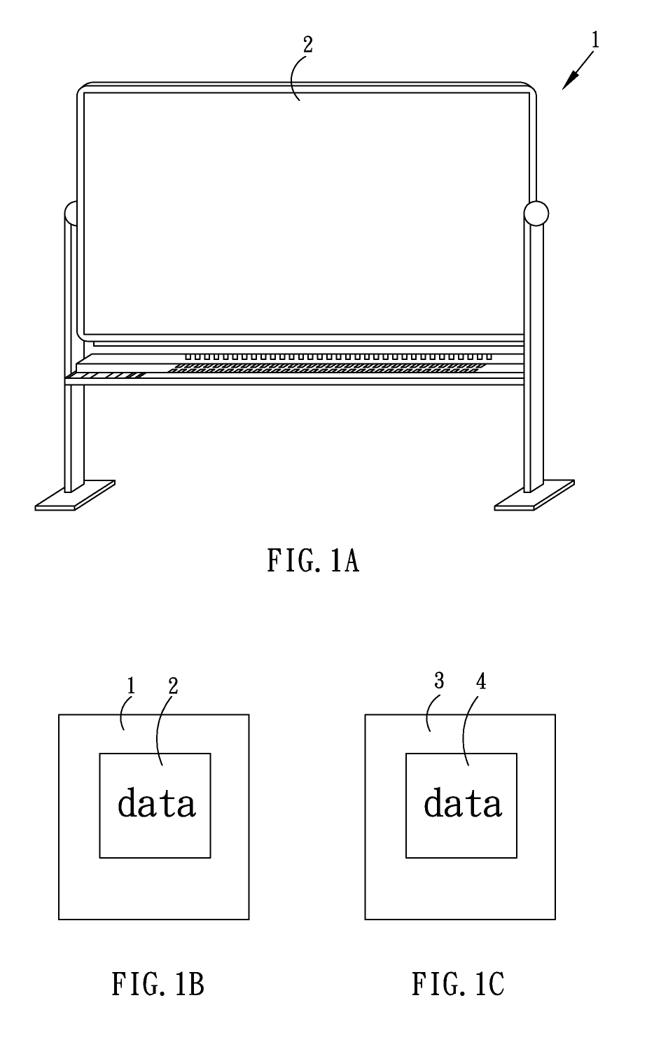

### DESCRIPTION OF THE EXEMPLARY EMBODIMENTS

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

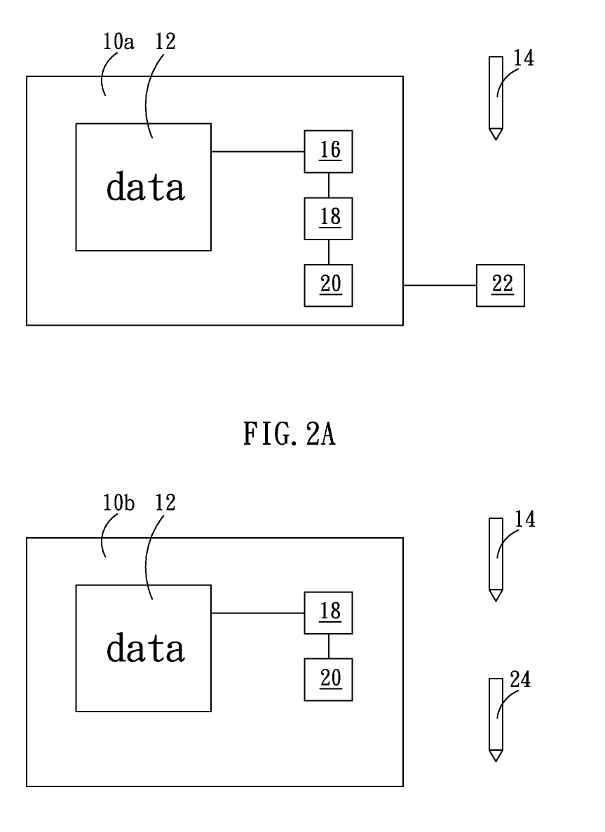

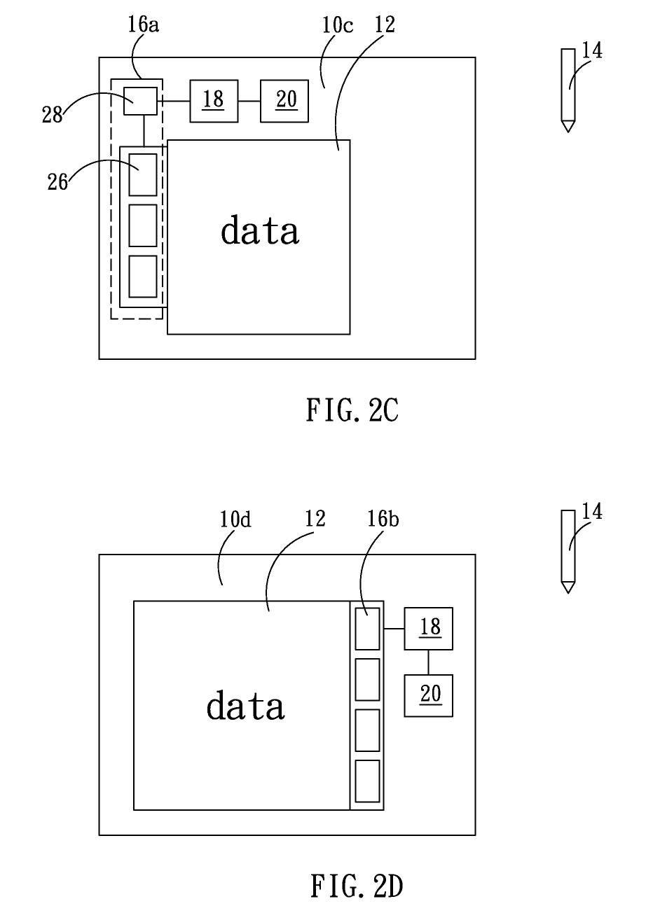

Referring to FIG. 2A, it is plane-form view of non-interactive electronic white boards 10a in accordance with one embodiment of the present invention. Non-interactive electronic white board 10a comprises a writing area 12 for inputting data of symbols, words, or drawings to the electronic white board 10a by writing the data of symbols, words, or drawings thereon, a selecting device 16 for selecting an area on the writing area wherein data in the area are selected to be printed, and a defining device 18 for defining a scope of the area. Non-interactive electronic white boards 10a is an electromagnetic electronic white boards and it further comprises a pen 14 for writing symbols, words, or drawings on the writing area 12. The defining device 18 defines a rectangle zone, a circle zone, an elliptical zone or a polygonal zone to be a printing area on the writing area 12 by inputting one or more points or lines with the selecting device 16. Only the data in the printing area is selected and printed by non-interactive electronic white board 10a.

Besides, non-interactive electronic white board 10a further comprises a adjusting device 20 for adjusting printing size of the selected data to be printed on a paper, for example the size (or printing size) of the symbols, words, or drawings on paper, wherein the symbols, words, or drawings is selected to be printed by selecting device 16 or in a area selected by selecting device 16. The size of the selected data on the writing area 12 is shrunk or enlarged to match the size of a paper, and then, it is printed on the paper with this shrunk size or enlarged size. Or the selected data on the writing area 12 is printed on a paper with the original size. By the way, the size of the data for printing on a paper is adjusted to be a size suiting to be read by the adjusting device 20. In this embodiment, all of the writing area 12, the selecting device 16, the defining device 18 and adjusting device 20 for printing the data on the writing area 12 are configured in or on the non-interactive electronic white boards 10a. The non-interactive electronic white board 10a further comprises a printing device 22, for example a printer. The printing device 22 is configured in the non-interactive electronic white boards 10a, as FIG. 2A shows, or it is connected with the non-interactive electronic white boards 10a in another embodiment.

Referring to FIG. 2B, it is plane-form view of non-interactive electronic white board 10b in accordance with another embodiment of the present invention. The stricture of the non-interactive electronic white board 10b is similar with the structure of the non-interactive electronic white board 10a. However, the non-interactive electronic white board 10b comprises a pen 14 for writing symbols, words, or drawings on the writing area 12 and a selecting pen 24 to instead of the selecting device 16 for selecting an area on the writing area 12 to be printed. The selecting pen 24 can directly select which part of data written on the writing area 12 or which area on the writing area to be printed. The frequency of a signal sent by the selecting pen 24 is different from the frequency of a signal sent by the pen 14, and it's motion performed on the writing area 12 is defined as a selecting motion by the non-interactive electronic white board 10b for selecting a printing area on the writing area 12. By the way, the selecting motion of the selecting pen 24 performed on the writing area 12 won't be confused with the writing motion of the pen 14, and the selecting pen 24 can input one or more points or lines for defining for selecting a printing area. The scope of the printing area can be defined by the points or lines inputted by the selecting pen 24.

Referring to FIG. 2B again, in another embodiment of a non-interactive electronic white board, which has the same structure with the non-interactive electronic white board 10b, the frequency of a signal sent by the selecting pen 24 is the same with the frequency of a signal sent by the pen 14, but the waveform of a signal sent by the selecting pen 24 is different from the waveform of a signal sent by the pen 14. The waveform of a signal sent by the selecting pen 24 is defined as the waveform of a selecting signal, and it's motion performed on the writing area 12 is defined as a selecting motion, but not a writing or inputting motion. By the way, the selecting pen 24 can input one or more points or lines for defining for selecting a printing area. The scope of the printing area can be defined by the points or lines inputted by the selecting pen 24.

Besides, in still another embodiment which has the similar structure with the non-interactive electronic white board 10b, a pen capable of changing the frequency or waveform of a signal sent by itself is applied to instead of the pen 14 and the selecting pen 24 illustrated in FIG. 2B. This pen is applied for writing and selecting. The pen can send at least two signals with different frequencies or waveforms, and the frequency or the waveform of the pen can change between the two frequencies or between the two waveforms. Each of the two frequencies or each of the two waveforms is defined a different function of said pen, for example one of the two frequencies or the two waveforms is defined as the frequency or the waveform of the writing signal sent by the pen and the other of the two frequencies or the two waveforms is defined as the frequency or the waveform of the selecting signal sent by the pen. Therefore, the motion of the pen performed on the writing area will be defined as a selecting motion when the frequency or the waveform is changed from one of the two he two frequencies or the two waveforms to another of the two he two frequencies or the two waveforms.

Referring to FIG. 2C, it is plane-form view of non-interactive electronic white board 10c in accordance with another embodiment of the present invention. The stricture of the non-interactive electronic white board 10c is similar with the structure of the non-interactive electronic white board 10b. However, comparing with the non-interactive electronic white board 10b, the non-interactive electronic white board 10c has only one pen 14 for inputting data by writing and the selecting device of the non-interactive electronic white board 10c comprises a function selecting device 16a for defining or selecting the function of the pen 14 or the selecting device itself is a function selecting device 16a. The function selecting device 16a comprises one or more electronic switches 26 configured on the non-interactive electronic white board 10c and a micro processor 28 in the non-interactive electronic white board 10c, such as microcontroller unit (MCU). When the electronic switch 26 is opened for controlling the micro processor 28, the form of the transferring envelope or the transferring envelope it self of the electronic white board 10c is changed by the micro processor 28. By this way, the function of the pen 14 is changed from a writing or inputting function to a selecting function. By changing the form of the transferring envelope or the transferring envelope it self of the electronic white board 10c, the area on the writing area 12, which is selected by the pen 14, will be defined as a scope of the printing area and the data in the area will be defined to be printed by the defining device 18. Therefore, only the data in the area selected by the pen 14 is printed without any data out of the area or any unselected data.

Referring to FIG. 2D, it is plane-form view of non-interactive electronic white board 10d in accordance with another embodiment of the present invention. The stricture of the non-interactive electronic white board 10d is similar with the structure of the non-interactive electronic white board 10c. However, comparing with the non-interactive electronic white board 10c, the function selecting device 16b of the non-interactive electronic white board 10c is a selecting block or bar configured on the writing area 12. When the pen touches the selecting block or bar, the form of the transferring envelope or the transferring envelope it self of the electronic white board 10d is changed for changing the function of the pen 14 from a writing or inputting function to a selecting function. Therefore, the area on the writing area 12, which is selected by the pen 14, will be defined as a scope of the printing area and the data in the area will be defined to be printed by the defining device 18. Accordingly, only the data in the area selected by the pen 14 is printed without any data out of the area or any unselected data.

In the non-interactive electronic white board 10a, 10b, 10c or 10d illustrated in FIG. 2A to FIG. 2D, the defining device 18 can be a hardware, such as a processor or a micro processor, or the defining device 18 can be a software, such as a program or a firmware. Besides, in one embodiment of the present invention, the defining device is integrated with the adjusting device into one device. In the non-interactive electronic white board 10a illustrated in FIG. 2A, the selecting device 16 can be a hardware, such as a processor or a micro processor, or the selecting device 16 can be a software, such as a program or a firmware. Furthermore, the selecting device 16 can be integrated with the defining device 18 or the adjusting device 20 into one device, or the selecting device 16 can be integrated with both of the defining device 18 and the adjusting device 20 into one device. In the non-interactive electronic white board 10d illustrated in FIG. 2D, the function selecting device 16b also can be a hardware or a software. No matter the defining device 18 is illustrated in the non-interactive electronic white board 10a, 10b, 10c or 10d and No matter the defining device 18 works with any of above-mentioned selecting device or selecting method, the methods to define scope of the area (or a printing area) on the writing area 12, which is selected by the selecting device, by the defining device 18 are listed and interpreted as following:

(1) the defining device defines scope of the area (or a printing area) on the writing area 12, which is selected for being printed by the selecting device, with a rectangle zone:

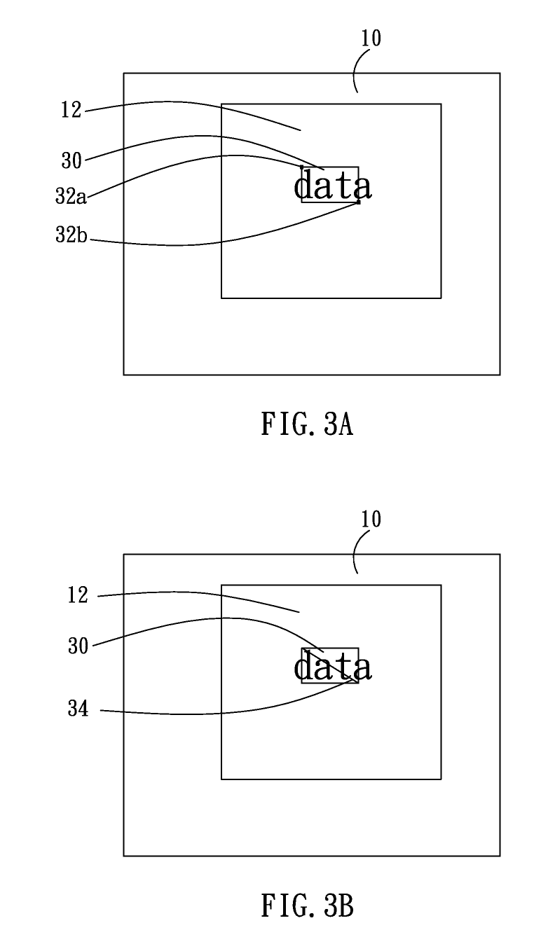

Referring to FIG. 3A, it is plane-form view of the writing area of a non-interactive electronic white board with a rectangle zone for defining the area to be printed in accordance with one embodiment of the present invention. Two points 32a and 32b (or coordinates of two points 32a and 32b) are inputted on the writing area 12 by the selecting device. The two points 32a and 32b are defines as two ends of a diagonal line of the rectangle zone 30 (or the area having a rectangle shape) by the defining device 18, and then, the scope (or size) of the printing area (or the rectangle zone 30) on the writing area 12 can be got by calculating with the two points 32a and 32b.

Referring to FIG. 3B, it is plane-form view of the writing area of a non-interactive electronic white board with a rectangle zone for defining the area to be printed in accordance with another embodiment of the present invention. An oblique line 34 is inputted on the writing area 12 by the selecting device. The t oblique line 34 is defines as a diagonal line of the rectangle zone 30 (or the area having a rectangle shape) by the defining device 18, and then, the scope (or size) of the printing area (or the rectangle zone 30) on the writing area 12 can be got by calculating with the oblique line 34.

(2) the defining device defines scope of the area (or a printing area) on the writing area 12, which is selected for being printed by the selecting device, with a circle zone:

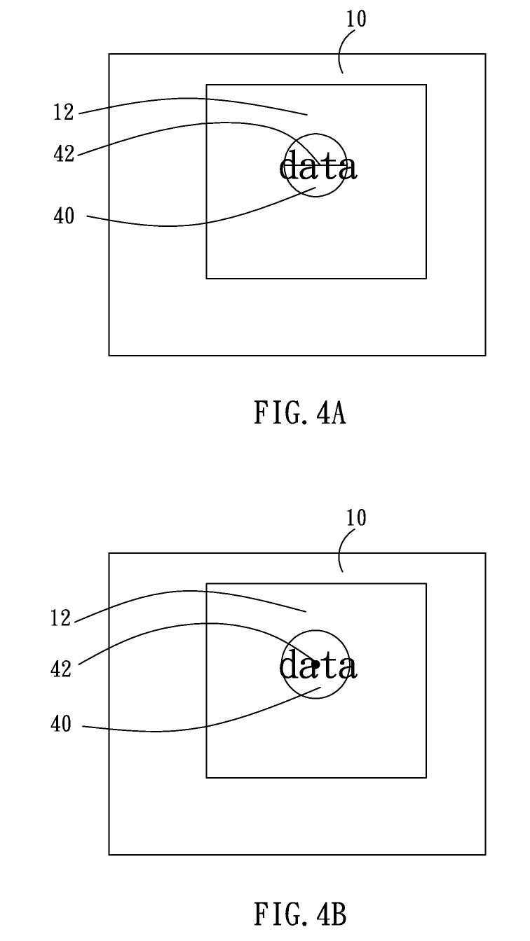

Referring to FIG. 4A, it is plane-form view of the writing area of a non-interactive electronic white board with a circle zone for defining the area to be printed in accordance with one embodiment of the present invention. A straight line 42 is inputted on the writing area 12 by the selecting device. The straight line 42 is defines as a diameter of a circle zone 40 (or the area having a circle shape) by the defining device 18, and then, the scope (or size) of the printing area (or the circle zone 40) on the writing area 12 can be got by calculating with the straight line 42.

Referring to FIG. 4B, it is plane-form view of the writing area of a non-interactive electronic white board with a circle zone for defining the area to be printed in accordance with another embodiment of the present invention. A point 44 (or coordinates of the point 44) is inputted on the writing area 12 by the selecting device. The point 44 is defines as the center of a circle zone 40 (or the area having a circle shape) by the defining device 18, and a diameter or radius of the circle zone 40 is predetermined in the electronic white board or is selected by the selecting device or another device, such as a pen. And then, the scope (or size) of the printing area (or the circle zone 40) on the writing area 12 can be got by calculating with the point 44 and the diameter or radius which is predetermined or selected.

(3) the defining device defines scope of the area (or a printing area) on the writing area 12, which is selected for being printed by the selecting device, with an elliptical zone:

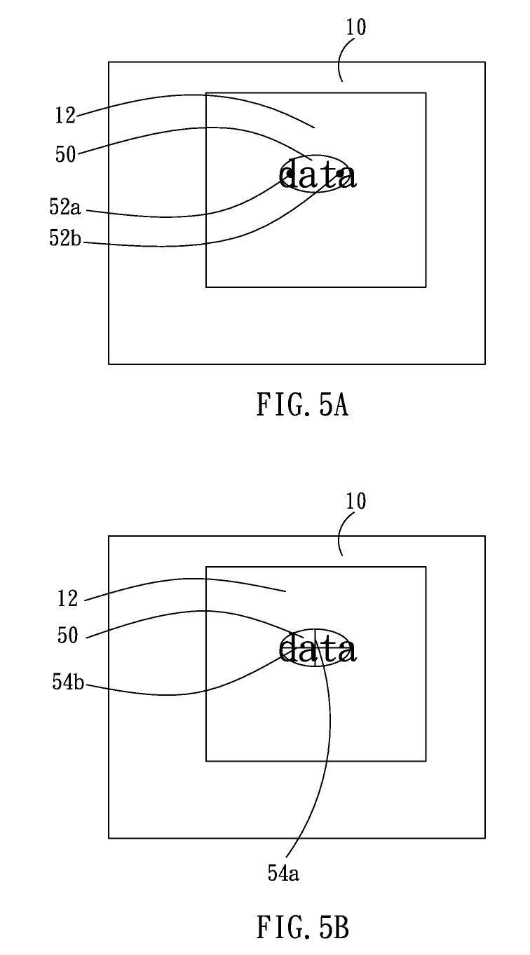

Referring to FIG. 5A, it is plane-form view of the writing area of a non-interactive electronic white board with an elliptical zone for defining the area to be printed in accordance with one embodiment of the present invention. Two points 52a and 52b (or coordinates of two points 52a and 52b) are inputted on the writing area 12 by the selecting device. The two points 32a and 32b are defines as two centers of the elliptical zone 50 (or the area having an elliptical shape) by the defining device 18, and then, the scope (or size) of the printing area (or the elliptical zone 50) on the writing area 12 can be got by calculating with the two points 32a and 32b.

Referring to FIG. 5B, it is plane-form view of the writing area of a non-interactive electronic white board with an elliptical zone for defining the area to be printed in accordance with another embodiment of the present invention. Two straight lines 54a and 54b are inputted on the writing area 12 by the selecting device. The two straight lines 54a and 54b are perpendicular to one another and they have different length. The two straight lines 54a and 54b are defines as two diameters of the elliptical zone 50 (or the area having an elliptical shape) by the defining device 18, and then, the scope (or size) of the printing area (or the elliptical zone 50) on the writing area 12 can be got by calculating with the two straight lines 54a and 54b.

(3) the defining device defines scope of the area (or a printing area) on the writing area 12, which is selected for being printed by the selecting device, with a polygonal zone:

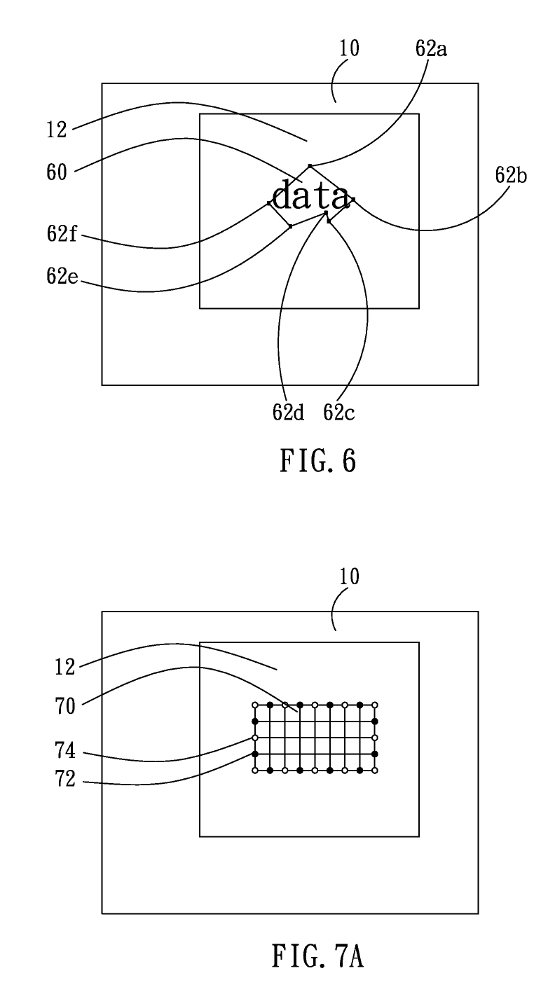

Referring to FIG. 6, it is plane-form view of the writing area of a non-interactive electronic white board with a polygonal zone for defining the area to be printed in accordance with one embodiment of the present invention. Several points 62a, 62b, 62c, 62d, 62e and 62f (or coordinates of the points 62a, 62b, 62c, 62d, 62e and 62f) are inputted on the writing area 12 by the selecting device. The points (62a-62f) are defines as vertices of the polygonal zone 60 (or the area having a polygonal shape) by the defining device 18, and then, the scope (or size) of the printing area (or the polygonal zone 60) on the writing area 12 can be got by calculating with the points 62a, 62b, 62c, 62d, 62e and 62f.

In the present invention, the size of the data in the area on the writing area 12, which is selected by the selecting device, is adjusted, such as be shrunk or enlarged before printing. The methods for adjusting printing size of the data in the area to be printed on a paper by the adjusting device are listed and interpreted as following:

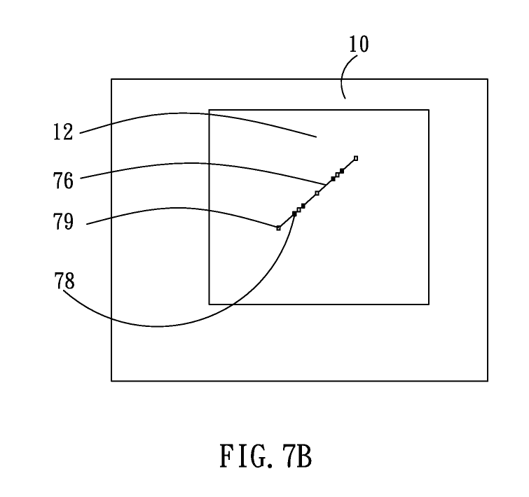

(a) Referring to FIG. 7A is plane-form view of the writing area of non-interactive electronic white board for adjusting the printing size on a paper in accordance with one embodiment of the present invention. Each edge of the area on the writing area 12 selected by the selecting device is divided into several coordinates 72, 74 (or coordinate points 72, 74) with equal distance. It means that the distances between any two adjacent coordinates in each edge of the area are the same. Part of coordinates in each edge of the area are picked to be positioning points for printing the data in the area to a paper. For example, only the coordinates 74 (the white points in FIG. 7A) is picked to be the positioning points wherein each coordinate 74 is separated from next coordinate 74 by at least one coordinate 72. By this way, the size of data to be printed on a paper can be adjusted. In another embodiment of the present invention, several coordinates on the writing area are directly picked to be the positioning points of the data in the selected area for being printed on a paper. Each positioning point is separated from next positioning point by more coordinates, for example two, three or more positioning point, or each positioning point is separated from next positioning point without any coordinate between them.

(b) Referring to FIG. 7B is plane-form view of the writing area of non-interactive electronic white board for adjusting the printing size on a paper in accordance with another embodiment of the present invention. Coordinate of each positioning point of the data for printing on a paper is calculated from each of the coordinates of the area (or of the data in the area), such as the coordinates 78 of the straight line 76 illustrated in FIG. 7B, by a linear formula aX+b=Y. The value a and the value b are adjusted according to the size of a paper. By this way, the data in the selected area on the writing area is equal proportion printed on a paper. In the linear formula, X represents original coordinate of the selected data on the writing area, Y represents a coordinate of the selected data for printing on a paper (or a coordinate of the selected data on a paper) For example, a straight line is inputted on the writing area, wherein the coordinates of two ends of the straight line are (1,1) and (1,2) respectively and the length of the straight line is 1. In this example, the value a and the value are 0.5 and 0. After the coordinates of two ends (1,1) and (1,2) are substituted into the linear formula aX+b=Y, the coordinates of the two ends (0.5,0.5) and (1,0.5) of the straight line on a page is gotten by the calculation. The length of the straight line printed on a paper is 0.5 and the length of the straight line printed on a paper is half of the original length of the straight line on the writing area.

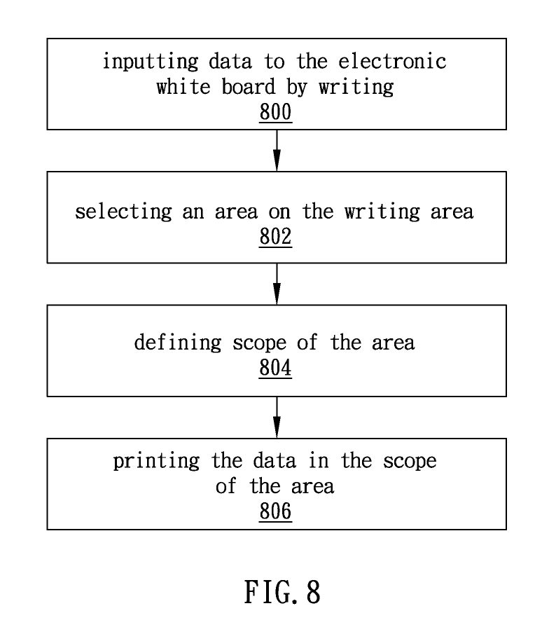

Furthermore, the present invention further provides a method for printing partial data on an electronic white board. Referring to FIG. 8, it is a flow chart illustration of a method for printing partial data on an electronic white board in accordance with an embodiment of the present invention. First, data of symbols, words, or drawings is inputted on a writing area of an electronic white board by writing (step 800). Next, one or more points or lines is inputted on the writing area for selecting an area or partial data on the writing area for printing (step 802). And then, scope of the area for printing with a rectangle zone, a circle zone, an elliptical zone or a polygonal zone is defined (step 804). Finally, the data in the selected area is printed on a paper by a printer (step 806).

In the step 800, the data is inputted or written on the writing area by a pen (or a digital pen). In the step 802, the area or the partial data on the writing area is selected by a selecting device. The selecting device is illustrated in FIG. 2A, FIG. 2B, FIG. 2C and FIG. 2D and is detailed in prior description, and it will be not mentioned herein again. The step 804 of defining the scope of the area for printing is defined by a defining device. The defining device and the defining method are detailed in prior description, and they will be not mentioned herein again.

Besides, the method further comprises an adjusting step for adjusting printing size of the data in the area to be selected for printing on a paper, such as the size of the symbols, words, or drawings, which are selected, for printing on a paper, with a shrinking size, an enlarging size or an equal size. The symbols, words, or drawings are printed on the paper with proper size for reading. The adjusting method is detailed in prior description, and it will be not mentioned herein again.

Therefore, the present invention provides an electronic white board capable of printing partial data thereon and a method for printing partial data on an electronic white board. By a selecting device and a defining device, an area on a writing area is selected and defined as a printing area and the data in the printing area is defined as the data desired to be printed. Therefore, only the desired data of symbols, words, or drawings is selected and printed, but not all data on the writing area of the electronic white board is printed. And only the important and selected data on the writing area is printed on a paper without any undesired and unselected data being printed. The printing size of the data in the area selected for printing on a paper, such as the size of the symbols, words, or drawings, which are selected, for printing on a paper, with a shrinking size, an enlarging size or an equal size. The symbols, words, or drawings are printed on the paper with proper size for reading.

What is claimed is:

1. A electronic white board capable of printing partial data, comprising:
a writing area for inputting data to said electronic white board by writing;
a selecting device for selecting a area on said writing area wherein data in said area are selected to be printed; and
a defining device for defining a scope of said area.

2. The electronic white board of claim 1, wherein said selecting device is a pen which can send at least two signals with different frequencies or waveforms, and each of said frequencies or waveforms representing different functions of said pen.

3. The electronic white board of claim 1, wherein said selecting device is a selective pen, and said selecting pen can directly select which part of data written on said writing area to be printed.

4. The electronic white board of claim 1, wherein said selecting device comprise a pen and a function selecting device.

5. The electronic white board of claim 4, wherein said function selecting device is a selecting block or bar on said writing area.

6. The electronic white board of claim 5, wherein said electronic white board changes the form of it's transferring envelope or changes said transferring envelope itself when said pen touches said selecting block or bar, and then, said area selected by said pen is defined as a scope of said area and data in said area on said writing area defined to be printed by said defining device.

7. The electronic white board of claim 1, wherein a rectangle zone, a circle zone, an elliptical zone or a polygonal zone is provided on said writing area by said defining device for defining said area to be printed.

8. The electronic white board of claim 1, further comprising an adjusting device for adjusting printing size of said data in said area to be printed on a paper.

9. The electronic white board of claim 8, wherein said adjusting device picks several coordinates of said area or of said data in said area to be positioning points of said data for printing on a paper.

10. The electronic white board of claim 8, wherein said adjusting device gets several positioning points for printing on a paper according to a linear formula aX+b=Y, wherein said X represents original coordinate, Y represents a coordinate of said data for printing on a paper, and a and b are parameters adjusted according to the size of said paper.

11. A method for printing partial data on an electronic white board, comprising:
inputting data to the electronic white board by writing;
selecting an area on said writing area wherein data in said area are selected to be printed;
defining scope of said area; and
printing said data in said scope of said area.

12. The method white board of claim 11, wherein said step of selecting part of the data or an area on the writing area to be printed is performed by a selecting device.

13. The method white board of claim 12, wherein said selecting device is a pen which can input at least two signals with different frequencies or waveforms, and each of said frequencies or waveforms representing different functions of said pen.

14. The method white board of claim 12, wherein said selecting device is a selective pen, and said selecting pen can directly select which part of data written on said writing area for printing.

15. The method white board of claim 12, wherein said selecting device comprise a pen and a function selecting device.

16. The method white board of claim 15, wherein said function selecting device is a selecting block or bar on said writing area.

17. The method white board of claim 16, wherein said electronic white board changes the form of it's transferring envelope or changes said transferring envelope itself when said pen touches said selecting block or bar, and then, said area selected by said pen is defined as a scope of said area and data in said area on said writing area defined to be printed by said defining device.

18. The method white board of claim 11, wherein said step of defining scope of said part of the data or of said area is performed by defining a rectangle zone, a circle zone, an elliptical zone or a polygonal zone provided.

19. The method white board of claim 11, further comprising an adjusting step for adjusting printing size of said data in said area to be printed on a paper.

20. The method white board of claim 19, wherein said adjusting step is performed by picking several coordinates of said area or of said data in said area to be positioning points of said data for printing on a paper, and each of picked positioning points is separated form another picked positioning point by a positioning point without being picked.

21. The method white board of claim 19, wherein said adjusting step is performed by geting several positioning points for printing on a paper according to a linear formula aX+b=Y, wherein said X represents original coordinate, Y represents a coordinate of said data for printing on a paper, and a and b are parameters adjusted according to the size of said paper.
